(19) United States
(12) Patent Application Publication
(10) Pub. No.: US 2002/0157102 A1
(43) Pub. Date: Oct. 24, 2002

(54) Moving picture streaming method in VOD system

(75) Inventors: Sanghyup Lee, Seoul (KR); KyoungWoo Lee, Seoul (KR); ByungDal Jung, Anyang-si (KR)

Correspondence Address: JONATHAN Y. KANG, ESQ., LEE & HONG P.C., 11th Floor, 221 N. Figueroa Street, Los Angeles, CA, 90012-2601, US

(73) Assignee: LG Electronics Inc.

(21) Appl. No.: 10/118,420

(22) Filed: Apr. 8, 2002

(30) Foreign Application Priority Data
Apr. 18, 2001 (KR) 20872/2001

(51) Int. Cl. H04N 7/173; G06F 15/16

(52) U.S. Cl. 725/93; 725/91; 709/219

(57) ABSTRACT

Disclosed is a moving picture streaming method in a VOD system, which selects moving pictures according to a level of a bandwidth in which a client is connected to a server, wherein the level is selected from group including five levels in the descending order, wherein the five levels includes: a first level for streaming all of at least one I picture, at least one P picture and at least one B picture of the video picture together with the audio; a second level for streaming the I and P pictures of the video picture together with the audio; a third level for streaming the I picture of the video picture together with the audio; a fourth level for streaming a portion of the I picture of the video picture together with the audio; and a fifth level for streaming the audio only. The moving pictures are efficiently transmitted regardless of a network environment of the client.

### BACKGROUND OF THE INVENTION

1. Field of the Invention

The present invention relates to a moving picture streaming method in a Video On Demand (VOD) system. In particular, when streaming a moving picture file, a main server packets moving pictures into the association of pictures according to a network bandwidth in order to stably provide the moving pictures regardless of network environments of clients, e.g. a modem, the ISDN, the ADSL, the LAN and the like.

2. Field of the Invention

Recently, development of telecommunication technologies and computers causes rapid development of the Internet, which enables a user to be provided with moving pictures as well as texts and still pictures.

Clients connect to a server via a variety of network environments in order to receive files such as the texts, the still pictures and the moving pictures transmitted via the Internet.

In the meantime, the network environments are varied according to the clients and examples thereof mainly include a modem, the ISDN, the ADSL, the LAN and the like, in which the modem has a relatively low bandwidth (e.g. 28.8 kbps), and the LAN is served at a relatively high bandwidth (e.g. 100 Mbps).

However, a client having a low bandwidth network environment such as the modem meets a problem that interruption frequently takes place, for example, in transmission of moving picture information which requires a high bit rate. Such a problem occurs since the information is encoded higher than the bandwidth of the network to which the client is connected.

Further, since the Internet is a packet switch network, the client has an unstable bandwidth which frequently varies according to time.

Being variable according to environment and time, the above Internet bandwidth is not adequate to a VOD system requiring a constant bit rate. In particular, the Internet bandwidth is more inadequate in transmission of the moving pictures requiring a high bit rate.

In order to overcome the above problem, the VOD system frequently produces a plurality of moving picture files at various bit rates for one content so that the files can satisfy various client network environments.

Therefore, it is required for a contents producer to make the plurality of moving picture files for the one content thereby resulting in waste of time, endeavor and database for producing the moving picture files.

Further, the client provided with the moving picture information should have knowledge about the network bandwidth in order to receive a moving picture file adequate to the network bandwidth of the client.

FIG. 1 shows a VOD system of the related art.

Referring to FIG. 1, the VOD system includes a visual device 100, an encoder 110, a main server 120 and clients 130a to 130d.

The visual device 100 displays moving pictures in response to analog signals, and examples thereof include a VTR, a TV, a camera and the like.

The encoder 110 converts the moving pictures composed of analog signals into moving picture files composed of digital signals.

The main server 120 selects one file with a suitable bit rate from the moving picture files with various bit rates which were previously provided from the encoder 110 and stored into the main server 120. The main server 120 transmits the selected moving picture file so that a client can regenerate the moving picture file without interruption.

More particularly, the main server 120 has the various files which are encoded into the various bit rates adequate to the various network bandwidths. Again, the one moving picture file representing one content is encoded into the various moving picture files having the various bit rates adequate to the modem, the ISDN, the ADSL, the LAN and the like, and the various moving picture files encoded into the various bit rates are previously stored into the main server 120.

Each of the clients 130 can connect to the main server 120 using each of the network environments including the modem, the ISDN, the ADSL, the LAN and the like so as to receive a moving picture file suitable to the each network environment of the each client 130.

In the meantime, in receiving the moving picture file from the main server 120, the moving picture file selected by the each client 130 can have a higher bit rate over the bandwidth of a network connected to a computer of the client. However, if the moving picture file having the higher bit rate over the bandwidth of the network connected to the client's computer is regenerated, the client 130 necessarily carries out a rebuffering operation in repetition so that regeneration of the moving picture file is stopped and interrupted as drawbacks.

### SUMMARY OF THE INVENTION

Accordingly, the present invention has been made to solve the foregoing problems and it is an object of the present invention to transmit a moving picture file by packeting the same according to a temporally variable network bandwidth so as to stably provide a moving picture service without interruption regardless of the temporally variable network bandwidth.

Further, it is another object of the present invention to selectively transmit a moving picture file to be streamed according to a network to which a client is connected, so that a video and an audio of the moving pictures can be readily recognized during regeneration of the moving pictures as well as the moving pictures can be readily transmitted.

To achieve the above object, there is provided a moving picture streaming method in a VOD system, the method comprising the following steps of storing one moving picture file encoded for the identical content into a main server; connecting by a client to a main server to transmit an instruction message which requests moving picture information; fetching by the main server a moving picture file requested from the client in response to the instruction message transmitted from the client; diving by the main server an audio and a video of the fetched moving picture file; confirming by the main server a network bandwidth of the client connected via a network to select a video picture according to the bandwidth; and transmitting by the main server the selected video picture into the client.

In addition, the present invention provides a moving picture streaming method in a VOD system, the method comprising the following steps of requesting by a client a moving picture file stored in a main server; reading by the main server a first block of the moving picture file; dividing an audio and a video picture of the moving picture file; confirming a bandwidth of a network to which the client is connected; determining a level for selecting the video picture according to the bandwidth of the network; and transmitting by the main server the video picture and the audio into the client according to the selected level and regenerating by the client the video picture and the audio.

The level is one selected from group including five levels in the descending order of the bandwidth of the network, and wherein the five levels include a first level for streaming all of at least one I picture, at least one P picture and at least one B picture of the video picture together with the audio; a second level for streaming the I and P pictures of the video picture together with the audio; a third level for streaming the I picture of the video picture together with the audio; a fourth level for streaming a portion of the I picture of the video picture together with the audio; and a fifth level for streaming the audio only.

### BRIEF DESCRIPTION OF THE DRAWINGS

The above and other objects, features and other advantages of the present invention will be more clearly understood from the following detailed description taken in conjunction with the accompanying drawings:

FIG. 1 shows a VOD system of the related art;

FIG. 2 shows a VOD system according to an embodiment of the invention;

FIG. 3 shows the picture shape of a moving picture file according an embodiment of the invention; and

FIG. 4 is a flow chart illustrating a process of providing a moving picture file according to the invention.

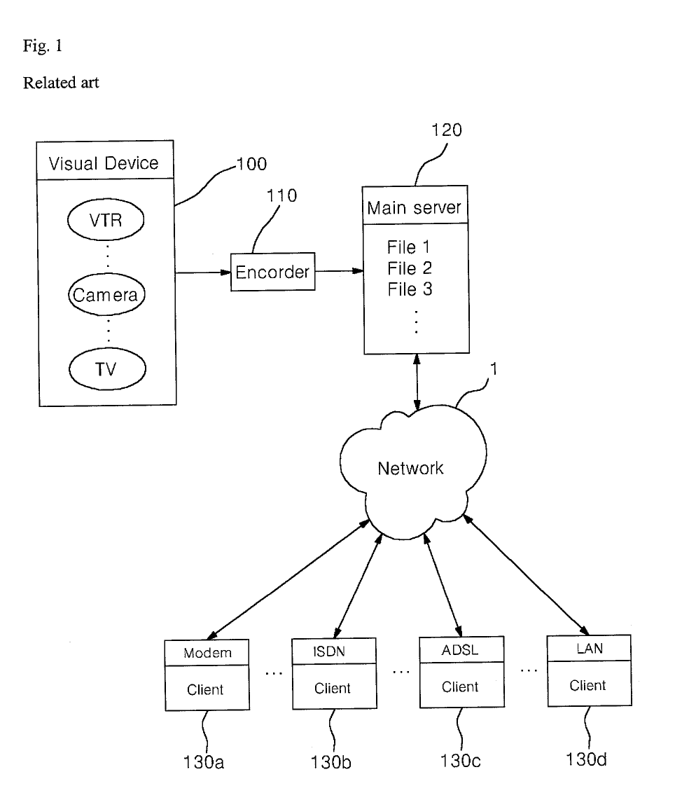

### DETAILED DESCRIPTION OF THE PREFERRED EMBODIMENT

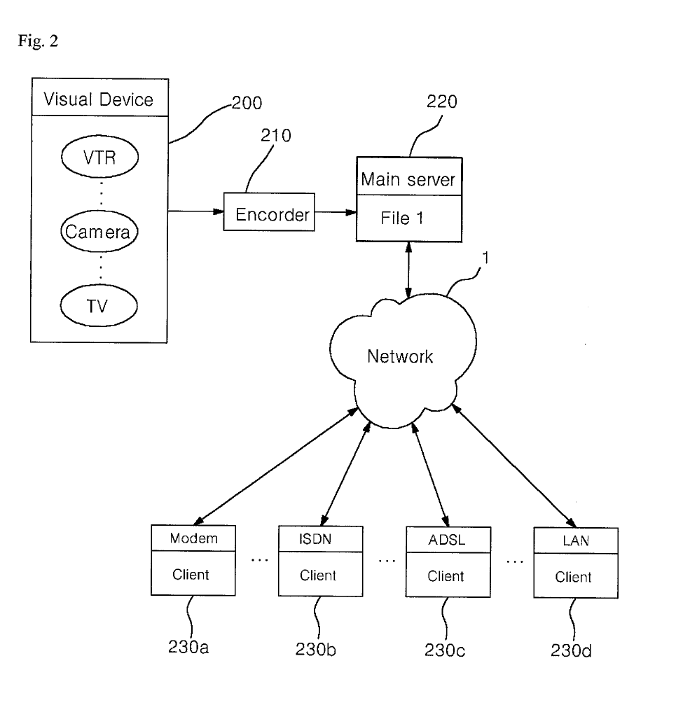

The following detailed description will present a moving picture streaming method in a VOD system according to a preferred embodiment of the invention in reference to FIGS. 2 to 4.

As shown in FIG. 2, the VOD system includes a visual device 200, an encoder 210, a main server 220 and clients 230.

The visual device 200 gathers picture information, and examples thereof may include a VTR, a TV, a camera and the like.

The encoder 210 receives moving pictures composed of analog signals from the visual device 200 so as to produce moving picture files, e.g. the MPEG1, the MPEG2, the MPEG4 and the H.263, in the form of digital signals.

The main server 220 receives moving picture request messages from the clients 230 so as to provide a VOD system service. In response to the request messages from the clients, the main server 220 fetches moving picture information, i.e. associated data of a video, an audio, a text and the like, desired by the clients from a database and streams the same.

Further, the main server 220 requires a single encoded moving picture file for one content thereby effectively reducing the storage capacity of the main server 220.

In the meantime, the main server 220 transmits a stream into each of the clients 230, in which the stream is data compressively encoded based upon an MPEG-2 algorithm. Examples of the stream may include a native ATM which is asynchronous transmission scheme used for improving transmission performance in a DAVLC.

In the meantime, in response to a VOD system service request transmitted from the each client 230 into the main server 220, an encoded bit stream and a bit stream of header information which are transmitted from the main server 220 into the each client 230 include transmission rate information of the server. Therefore, when restoring the encoded bit stream into the original signal before encoding, the each client 230 extracts the transmission rate information contained in the bit stream and determines a decoding speed in restoration based upon the extracted transmission rate information.

In the meantime, at least two channels are provided for communication between the main server 220 and the each client 230: The first one is a control channel, and the second one is a data channel. The control channel is connected between the each client and the main server for transmitting instruction messages which are applied for exchange of messages generated between both parts, i.e, the each client and the main server. The data channel is used for transmitting a moving picture file from the main server into the each client.

The instruction messages between the main server 220 and the each client 220 may have the following forms:

A connect instruction message is used when the each client 230 tries connection to the main server 220; a play instruction message is used when the main server 220 starts moving picture transmission; a pause instruction message is used when the moving picture transmission is temporarily suspended; a stop instruction message is used when the moving picture transmission is terminated; and a disconnect instruction message is used for clearing connection to the main server.

In this case, the main server 220 divides the moving picture file into five levels so that the moving picture file is stably transmitted into the client 230.

Further, the main server 220 provides the moving picture file in one of the levels corresponding to the transmission speed of the each client 230 so as to guarantee stable moving picture transmission.

In particular, when transmitting the moving picture file into the each client 230, the main server 220 transmits the moving picture file in a level suitable to a temporally variable network bandwidth of the each client 230, i.e. the transmission speed of the network.

The invention divides the moving picture file provided into the clients into the five levels according to network bandwidths to provide a moving picture service in the level suitable to the network bandwidth of the each client.

The above levels will be described in more detail as follows:

In level 1, the main server streams all of I pictures, P pictures and B pictures of the video together with the audio. Moving pictures in the level 1 can be applied when the each client has a network bandwidth sufficient to receive the entire moving pictures.

In level 2, the main server streams only the I pictures and P pictures of the video together with the audio.

In level 3, the main server streams only the I pictures of the video together with the audio.

In level 4, the main server streams a portion of the I pictures of the video together with the audio. Describing in detail, streaming is carried out by leaping some of the I pictures.

In the levels 2 to 4, the audio can be naturally heard, whereas the video is not so natural as in the level 1 since the video lacks the P and/or B pictures. However, this can effectively remove interruption or rebuffering due to an encoding rate higher than the bandwidth of the network.

In level 5, only the audio is streamed. The client provided with the moving picture file in the level 5 has a very low bandwidth, and thus only can hear the audio but cannot watch the video.

The unit of levels as set forth above is an exemplary unit for associating the data sizes of the audio and the video but will not be restricted into the above mentioned form.

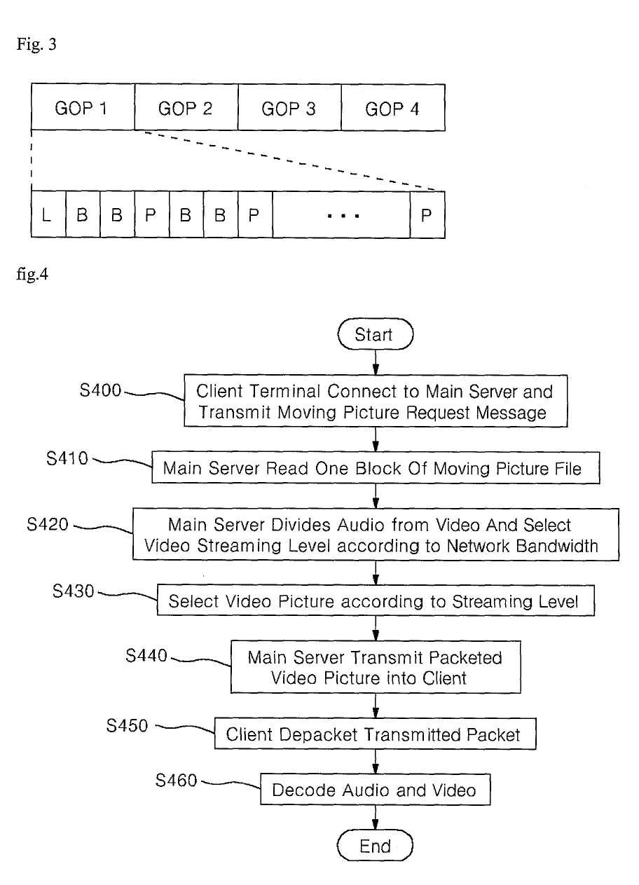

FIG. 3 shows the picture shape of a moving picture file according an embodiment of the invention.

Referring to FIG. 3, meaning of the above levels will be described in more detail.

Moving picture files such as the MPEG1, the MPEG2, the MPEG4 and the H.263 include an audio and a video, respectively. The video is composed in the unit of GOPs (Group of Pictures), in which each of the GOPs is composed of I, B and P pictures.

The I pictures have a complete form and thus are decodable separately. The P pictures have dependency to the I pictures and thus are decoded together with the I pictures. The B pictures have dependency to the I and P pictures and thus are decodable when the I pictures separately exist or both of the I and B pictures exist.

In the meantime, upon receiving a request message for the moving picture file from the each client 230 (FIG. 2), the server 220 (FIG. 2) streams the moving pictures 5 into the level according to the bandwidth of the network to which the each client is connected. Then, the level of the moving pictures transmitted according to the bandwidth of the network is selected from the plurality of moving picture levels as set forth above.

To be more specific, when the bandwidth of the network to which the each client is connected, transmission is executed in the level 1 where all of the I pictures, the P pictures and the B pictures are streamed so that the each client can watch complete pictures by decoding all of the pictures. However, since the level is increased as the bandwidth of the network connected with the each client is lowered, the complete pictures are not formed even if all of the pictures are decoded. In the meantime, this effectively restrains interruption of pictures which is generated since the bandwidth of streaming is low.

FIG. 4 is a flow chart illustrating a process of providing a moving picture file according to the invention.

As shown in FIG. 4, the each client 230 connects to the main server 220 in order to receive moving pictures according to a VOD system service, and transmits a moving picture request message to the main server 220 in S400.

In the meantime, the main server 220 reads one block of a moving picture file requested from the each client 230 in S410.

The main server 220 divides an audio from a video, and selects the level of streaming according to the bandwidth of the network to which the each client 230 is connected in S420.

After video pictures are selected in association of I, P and B pictures according to the selected video streaming level in S430, the main server 220 transmits the selected video pictures into the each client after packeting the same in S440.

The each client depackets the received video pictures in S450, and regenerates the audio and video through decoding in S460.

It will be presented another embodiment of the invention as follows:

The first embodiment of the invention can be applied as it is. However, the bandwidth may vary due to factors such as unstableness of the network. In this case, the network bandwidth is confirmed and the video streaming level is selected again whenever a specific block of the moving picture file is called, so that the each client can watch the moving pictures without interruption from the beginning to the end.

The block can be described according to one unit where one moving picture file is divided.

According to the moving picture streaming method in the VOD system of the invention as set forth above, the moving pictures can be provided stably regardless of the network environments such as the modem, the ISDN, the ADSL and the LAN.

Further, the invention can stably provide the moving pictures without interruption regardless of the temporally variable network bandwidth.

Moreover, the main server possesses the one encoded moving picture file thereby reducing the load applied to the database of the main server.

What is claimed is:

1. A moving picture streaming method in a VOD system, the method comprising the following steps of:
storing one moving picture file encoded for the identical content into a main server;
connecting by a client to a main server to transmit an instruction message which requests moving picture information;
fetching by the main server a moving picture file requested from the client in response to the instruction message transmitted from the client;
diving by the main server an audio and a video of the fetched moving picture file;
confirming by the main server a network bandwidth of the client connected via a network to select a video picture according to the bandwidth; and
transmitting by the main server the selected video picture into the client.

2. The moving picture streaming method in a VOD system according to claim 1, wherein the video of the moving picture file is composed in the unit of GOP.

3. The moving picture streaming method in a VOD system according to claim 2, wherein the GOP comprises at least one I picture, at least one B picture and at least one P picture, wherein the I picture is decodable separately, the B picture is a compressed picture having dependency to the I picture, and the P picture has dependency to the I and B pictures.

4. A moving picture streaming method in a VOD system, the method comprising the following steps of:
requesting by a client a moving picture file stored in a main server;
dividing an audio and a video picture of the moving picture file;
confirming a bandwidth of a network to which the client is connected;
determining a level for selecting the video picture according to the bandwidth of the network; and
transmitting by the main server the video picture and the audio into the client according to the selected level and regenerating by the client the video picture and the audio.

5. The moving picture streaming method in a VOD system according to claim 4, wherein the level is one selected from group including five levels in the descending order of the bandwidth of the network, and wherein the five levels include:
(i) a first level for streaming all of at least one I picture, at least one P picture and at least one B picture of the video picture together with the audio;
(ii) a second level for streaming the I and P pictures of the video picture together with the audio;
(iii) a third level for streaming the I picture of the video picture together with the audio;
(iv) a fourth level for streaming a portion of the I picture of the video picture together with the audio; and
(v) a fifth level for streaming the audio only.

6. The moving picture streaming method in a VOD system according to claim 4, wherein the audio and the video picture are transmitted into the client in packet.

7. The moving picture streaming method in a VOD system according to claim 4, wherein the main server stores only one moving picture file for one content.

8. A moving picture streaming method in a VOD system, the method comprising the following steps of:
requesting by a client a moving picture file stored in a main server;
reading by the main server a first block of the moving picture file;
dividing an audio and a video picture of the moving picture file;
confirming a bandwidth of a network to which the client is connected;
determining a level for selecting the video picture according to the bandwidth of the network; and
transmitting by the main server the video picture and the audio into the client according to the selected level and regenerating by the client the video picture and the audio.

9. The moving picture streaming method in a VOD system according to claim 8, wherein the level is one selected from group including five levels in the descending order of the bandwidth of the network, and wherein the five levels include:
(i) a first level for streaming all of at least one I picture, at least one P picture and at least one B picture of the video picture together with the audio;
(ii) a second level for streaming the I and P pictures of the video picture together with the audio;
(iii) a third level for streaming the I picture of the video picture together with the audio;
(iv) a fourth level for streaming a portion of the I picture of the video picture together with the audio; and
(v) a fifth level for streaming the audio only.

10. The moving picture streaming method in a VOD system according to claim 8, wherein the moving picture has at least one second block, and when a new block is called in the unit of the blocks, the level is selected again and transmitted into the client.

11. A moving picture streaming method in a VOD system, the method selecting moving pictures according to a level of a bandwidth in which a client is connected to a server, wherein the level is selected from group including five levels in the descending order, wherein the five levels includes:
(i) a first level for streaming all of at least one I picture, at least one P picture and at least one B picture of the video picture together with the audio;
(ii) a second level for streaming the I and P pictures of the video picture together with the audio;
(iii) a third level for streaming the I picture of the video picture together with the audio;
(iv) a fourth level for streaming a portion of the I picture of the video picture together with the audio; and
(v) a fifth level for streaming the audio only.
